(19) United States
(12) Patent Application Publication
(10) Pub. No.: US 2013/0251071 A1
(43) Pub. Date: Sep. 26, 2013

(54) RECEIVER

(71) Applicants: Yutaka SHIMIZU, Kanagawa-ken (JP); Yoshiharu Nito, Kanagawa-ken (JP)

(72) Inventors: Yutaka SHIMIZU, Kanagawa-ken (JP); Yoshiharu Nito, Kanagawa-ken (JP)

(73) Assignee: KABUSHIKI KAISHA TOSHIBA, Tokyo (JP)

(21) Appl. No.: 13/604,311

(22) Filed: Sep. 5, 2012

(30) Foreign Application Priority Data
Mar. 21, 2012 (JP) 2012-064036

(51) Int. Cl. H04L 27/00

(52) U.S. Cl. 375/340

(57) ABSTRACT

A receiver includes a channel selection filter that receives an input signal, filters the input signal, and outputs the filtered input signal as a first signal, an amplifier that receives the first signal from the channel selection filter, amplifies the first signal, and outputs the amplified first signal as a second signal, a first detector that receives the second signal from the amplifier and outputs a third signal after delaying and detecting the second signal, a second detector that receives the second signal from the amplifier and outputs a fourth signal after performing pulse count detection or quadrature detection on the second signal, a switching circuit that selects one of the third signal and the fourth signal and outputs the selected signal as a demodulated signal through an output terminal, and a control circuit that controls the switching circuit to select either the third signal or the fourth signal.

### CROSS-REFERENCE TO RELATED APPLICATION

This application is based upon and claims the benefit of priority from Japanese Patent Application No. 2012-064036, filed Mar. 21, 2012; the entire contents of which are incorporated herein by reference.

### FIELD

Embodiments described herein relate to a receiver.

### BACKGROUND

Detection methods in conventional receivers include delayed detection, pulse count detection, quadrature detection, etc.

### DESCRIPTION OF THE DRAWINGS

FIG. 1 illustrates demodulation characteristics of delayed detection, pulse count detection, and quadrature detection methods.

FIG. 2 shows an interference wave characteristic, an input signal frequency offset resistance, and an out-of-band detection characteristic of a delayed detection method and pulse count detection and quadrature detection methods.

FIG. 3 shows an example configuration of a receiver according to a first embodiment.

FIG. 4 shows an example configuration of a receiver according to a second embodiment.

FIG. 5 shows an example configuration of a receiver according to a third embodiment.

### DETAILED DESCRIPTION

Embodiments disclosed herein provide a receiver that can improve an interference wave characteristic, an input frequency offset resistance, and an out-of-band detection characteristic of its output signals.

A receiver according to one embodiment is provided with a channel selection filter that receives an IF signal and outputs a filtered IF signal as a first signal, an IF amplifier that receives the first signal from the channel selection filter and outputs an amplified first signal as a second signal, a first detector that receives the second signal from the IF amplifier and outputs a third signal after the second signal is delayed and detected, a second detector that receives the second signal from the IF amplifier and outputs a fourth signal after the second signal undergoes pulse count detection or quadrature detection, a switching circuit that selects one of the third signal and the fourth signal and outputs the selected signal as a demodulated signal through an output terminal, and a control circuit that controls the switching circuit to select either the third signal or the fourth signal.

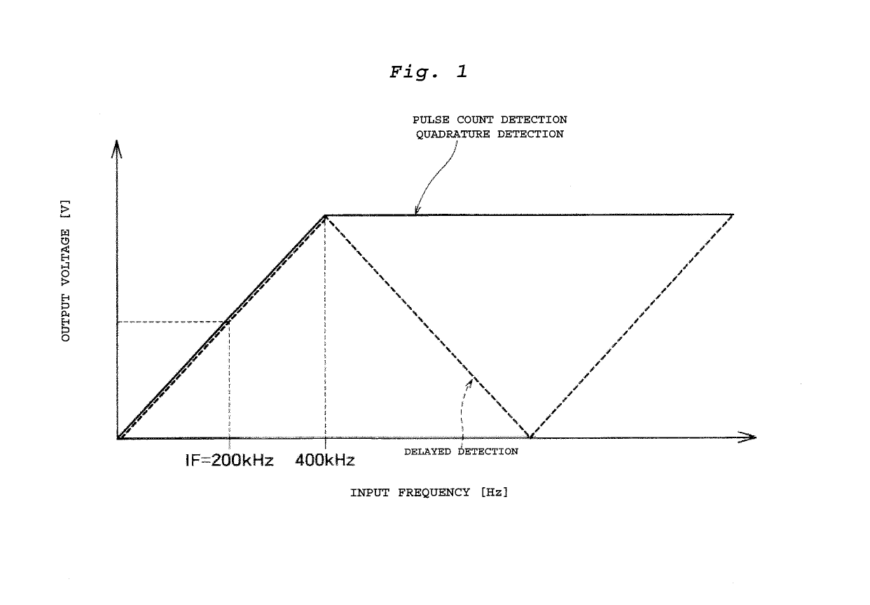

FIG. 1 illustrates demodulation characteristics of delayed detection, pulse count detection, and quadrature detection methods.

As shown in FIG. 1, the demodulation characteristics of the delayed detection, pulse count detection, and quadrature detection methods are similar from zero frequency to a certain frequency (e.g., 400 kHz in FIG. 1). However, the delayed detection method exhibits a characteristic where the output voltage response in relation to the input frequency is folded back (reverses slope) above the certain frequency as shown. In contrast, in the pulse count detection method and the quadrature detection method, the output voltage response in relation to an input frequency is constant above the certain frequency.

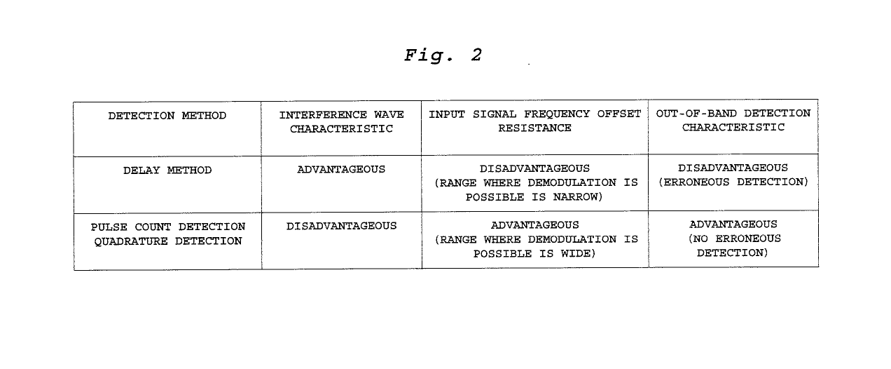

FIG. 2 shows the interference wave characteristic, input signal frequency offset resistance, and out-of-band detection characteristic of the delayed detection, pulse count detection, and quadrature detection methods.

As shown in FIG. 1, with the delayed detection method, the demodulation characteristic (e.g., output voltage response to input frequency) is folded back (reverses slope) near the band of interference waves (for example 400-1,600 kHz). As a result, demodulation voltage is suppressed, causing a high resistance. In the pulse count detection and the quadrature detection, by contrast, the demodulation characteristic is not folded back. As a result, a large demodulation voltage is output in response to interference waves, causing a low resistance.

As for the input signal frequency offset resistance, in the delayed detection, the output voltage is folded back at 400 kHz or higher (in the example given in FIG. 1), making demodulation of offsets in input signal frequency not possible at the higher frequency ranges. On the other hand, in the pulse count detection and quadrature detection methods, although output voltage distortion is caused, the input frequency offsets can be demodulated over a wider frequency range.

As for the out-of-band detection characteristic in which signals that are out-of-band are erroneously detected when there is no desired signal, it is disadvantageous to use the delayed detection method because signals are not discriminated from the desired signal in the delayed detection method. Thus, erroneous detection may result. On the other hand, no erroneous detection occurs in the pulse count detection and quadrature detection methods, because the demodulated signal is insignificant.

Therefore, there are respective advantages and disadvantages in the delayed detection, the pulse count detection, and the quadrature detection methods.

Accordingly, in the following Embodiments, receivers, which select detection methods in consideration of their respective advantages and disadvantages to improve the interference wave characteristic, input signal frequency offset resistance, and out-of-band detection characteristic, are proposed.

Next, each embodiment will be explained with reference to the figures.

(Embodiment 1)

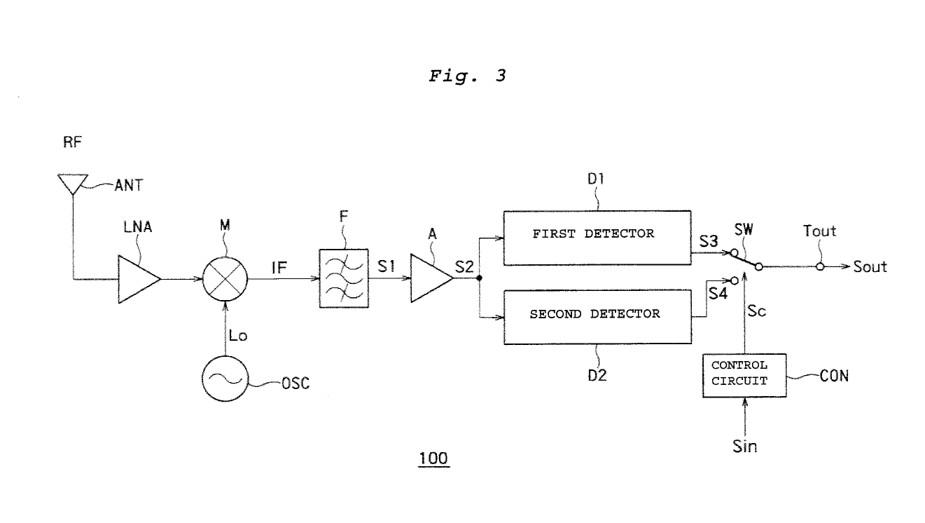

FIG. 3 shows an example configuration of a receiver 100 of Embodiment 1. As shown in FIG. 3, the receiver 100 is provided with antenna ANT, low-noise amplifier LNA, local oscillator OSC, mixer M, a channel selection filter F, IF amplifier A, first detector D1, second detector D2, switching circuit SW, and control circuit CON. In this embodiment, the receiver 100 is an FM receiver.

The antenna ANT receives a RF (radio frequency) signal. The low-noise amplifier LNA amplifies and outputs the RF signal received by the antenna ANT. The local oscillator OSC generates and outputs a local oscillating signal Lo. The mixer M outputs an IF (intermediate frequency) signal obtained by mixing the signal output from the low-noise amplifier LNA and the local oscillating signal Lo. The channel selection filter F receives the input of the IF signal, filters the IF signal, and outputs the filtered IF signal as a first signal S1 or a desired signal. The channel selection filter F may be a band pass filter or a low-pass filter.

The IF amplifier A receives the first signal S1 from the channel selection filter F, amplifies the first signal S1, and outputs the amplified first signal S1 as a second signal S2. The first detector D1 receives the second signal S2 from the IF amplifier A and outputs a third signal S3 after it has delayed and detected the second signal S2. The second detector D2 receives the second signal S2 from the IF amplifier A and outputs a fourth signal S4 after it has performed pulse count detection or quadrature detection on the second signal S2. The switching circuit SW selects one of the third signal S3 and the fourth signal S4 and outputs the selected signal as a demodulated signal Sout through an output terminal Tout.

The control circuit CON controls the switching circuit SW with a control signal Sc to detect either the third signal S3 or the fourth signal S4. In one embodiment, the control circuit CON controls the switching circuit SW in accordance with an external signal Sin that causes either the signal S3 or the fourth signal S4 to be selected. The external signal Sin is generated based on any of the following: interference wave characteristic, input signal frequency offset resistance, or out-of-band detection characteristic shown in FIG. 2, and supplied to the control circuit CON, which selects either the third signal S3 or the fourth signal S4 in accordance with the external signal Sin.

For example, when the input frequency offset resistance and the out-of-band detection characteristic are considered important as determined according to techniques known in the art, the control circuit CON as directed by the external signal Sin controls the switching circuit SW to select the third signal S3. On the other hand, when the interference wave characteristic is considered important as determined according to techniques known in the art, the control circuit CON as directed by the external signal Sin controls the switching circuit SW to select the fourth signal S4. Therefore, the receiver 100 changes the detection method in accordance with characteristics that are considered to be important.

With the receiver of Embodiment 1, the interference wave characteristic, the input signal frequency offset resistance, and the out-of-band detection characteristic can be improved.

(Embodiment 2)

Embodiment 2 provides an example in which the switching circuit is automatically controlled.

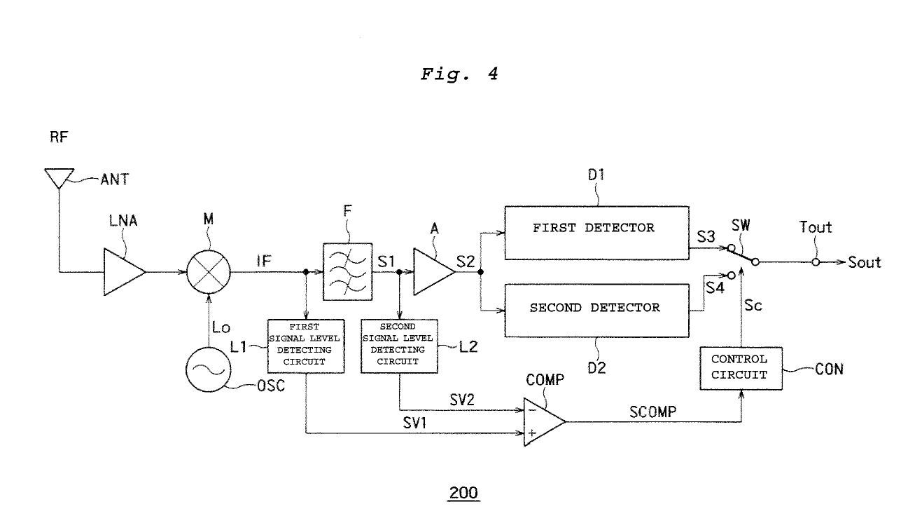

FIG. 4 shows an example configuration of a receiver 200 of Embodiment 2. In FIG. 4, the symbols of FIG. 3 are used to identify elements that are common between Embodiment 1 and Embodiment 2.

As shown in FIG. 4, as compared to Embodiment 1, the receiver 200 is further provided with a first signal level detecting circuit L1, a second signal level detecting circuit L2, and a comparator COMP.

The first signal level detecting circuit L1 detects a signal level (voltage level) of an IF signal. Then, the first signal level detecting circuit L1 outputs a first detected signal SV1 based on the detected signal level (referred to as a first level) of the IF signal. The second signal level detecting circuit L2 detects a signal level (voltage level) of a first signal S1. Then, the second signal level detecting circuit L2 outputs a second detected signal SV2 based on the detected signal level (referred to as a second level) of the first signal S1. The comparator COMP compares the first detected signal SV1, which has been output based on the first level by the first signal level detecting circuit L1, with the second detected signal SV2 output based on the second level by the second signal level detecting circuit L2, and outputs a comparison result signal SCOMP based on the comparison result.

The control circuit CON receives the comparison result signal SCOMP (instead of the signal Sin as in Embodiment 1) and obtains the comparison result of the first detected signal SV1 and the second detected signal SV2, that is, information on the size relation between the first level and the second level. Then, the control circuit CON controls the switching circuit SW based on this information. In other words, based on the first level, which is the signal level of the IF signal detected by the first signal level detecting circuit L1 and the second level, which is the signal level of the first signal S1 detected by the second signal level detecting circuit L2, the control circuit CON controls the switching circuit SW to select either the third signal S3 or the fourth signal S4.

In one embodiment, if the first level is higher than the second level, the control circuit CON controls the switching circuit SW so that the third signal S3 is selected. In some embodiments, the control circuit CON controls the switching circuit SW to select the third signal S3 only if the first level is higher than the second level by more than a preset threshold Vth.

In this case, the receiver 200 outputs the third signal S3, which has been delayed and detected by the first detector D1, as the demodulated signal Sout through the output terminal Tout.

Therefore, if the first level is higher than the second level, that is, if the level of interference waves is high, the receiver 200 automatically applies delayed detection to produce an output signal with excellent interference wave characteristics. On the other hand, if the first level is at the second level or lower, the control circuit CON controls the switching circuit SW to select the fourth signal S4. In some embodiments, if the first level is higher than the second level by the threshold Vth or lower, the control circuit CON controls the switching circuit SW to select the fourth signal S4. Thereafter, the receiver 200 outputs the fourth signal S4, which has undergone the pulse count detection or quadrature detection in the second detector D2, as the demodulated signal Sout through the output terminal Tout.

Therefore, if the first level is at the second level or lower, that is, if the level of interference waves is low, the receiver 200 automatically applies pulse count detection or quadrature detection to produce a signal with an excel lent input frequency offset resistance and out-of-band detection characteristics.

The control circuit CON controls the switching circuit based on the comparison result signal SCOMP to select either the third signal S3 or the fourth signal S4.

In Embodiment 2, other configurations and functions of the receiver 200 are similar to those of Embodiment 1. According to the receiver of Embodiment 2, the interference wave characteristic, the input signal frequency offset resistance, and the out-of-band detection characteristic can be improved similarly to Embodiment 1.

(Embodiment 3)

Embodiment 3 provides another example in which the switching circuit is automatically controlled.

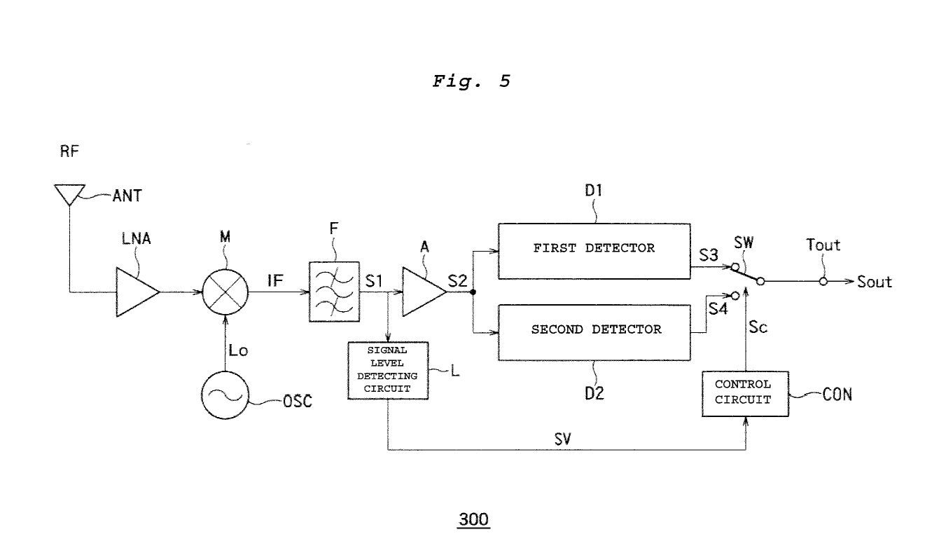

FIG. 5 shows an example configuration of a receiver 300 of Embodiment 3. In FIG. 5, the symbols of FIG. 3 are used to identify elements that are common between Embodiment 1 and Embodiment 3.

As shown in FIG. 5, as compared to Embodiment 1, the receiver 300 is further provided with a signal level detecting circuit L.

The signal level detecting circuit L detects a signal level (voltage level) of the first signal (desired signal) S1. Then, the signal level detecting circuit L outputs a detected signal SV based on the detected signal level of the first signal S1.

The control circuit CON receives the detected signal SV (instead of the signal Sin as in Embodiment 1) and obtains information on the detected signal level. Next, the control circuit CON controls the switching circuit SW based on this information. In other words, based on the detected signal level of the first signal S1, the control circuit CON controls the switching circuit SW to select either the third signal S3 or the fourth signal S4. For example, if the detected signal level is higher than a preset threshold Vth, the control circuit CON controls the switching circuit SW to select the third signal S3. Thereafter, the receiver 300 outputs the third signal S3, which has been delayed and detected by the first detector D1, as a demodulated signal Sout through the output terminal Tout.

Therefore, if the first level is higher than the threshold Vth, that is, the signal level of the desired signal is higher than the threshold Vth, the receiver 300 automatically applies delayed detection to produce an output signal with excellent interference wave characteristics.

On the other hand, if the detected signal level is equal to the threshold Vth or lower, the control circuit CON controls the switching circuit SW to select the fourth signal S4. Thereafter, the receiver 200 outputs the fourth signal S4, which has undergone the pulse count detection or quadrature detection in the second detector D2, as the demodulated signal Sout through the output terminal Tout.

Therefore, if the detected signal level is at the threshold Vth or lower, the receiver 300 automatically applies the pulse count detection or quadrature detection to produce an output signal with excellent input frequency offset resistance and out-of-band detection characteristics.

According to the receiver of Embodiment 3, the interference wave characteristic, the input signal frequency offset resistance, and the out-of-band detection characteristic can be improved similarly to Embodiment 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A receiver comprising:
a channel selection filter configured to receive an input signal, filter the input signal, and output the filtered input signal as a first signal;
an amplifier configured to receive the first signal from the channel selection filter, amplify the first signal, and output the amplified first signal as a second signal;
a first detector configured to receive the second signal from the amplifier, delay and detect the second signal, and outputs the delayed and detected second signal as a third signal;
a second detector configured to receive the second signal from the amplifier, perform pulse count detection or quadrature detection on the second signal, and output the second signal that has undergone pulse count detection or quadrature detection as a fourth signal;
a switching circuit configured to select one of the third signal and the fourth signal and output the selected signal through an output terminal as a demodulated signal; and
a control circuit configured to control the switching circuit to select one of the third signal and the fourth signal.

2. The receiver according to claim 1, wherein
the control circuit is configured to control the switching circuit in accordance with an external signal.

3. The receiver according to claim 1, further comprising:
a first signal level detecting circuit for detecting a signal level of the input signal as a first level; and
a second signal level detecting circuit for detecting a signal level of the first signal as a second level,
wherein the control circuit controls the switching circuit based on a difference in the first and second levels.

4. The receiver according to claim 3, wherein the control circuit is configured to control the switching circuit to select the third signal if the first level is higher than the second level and the fourth signal if the first level is not higher than the second level.

5. The receiver according to claim 3, wherein the control circuit is configured to control the switching circuit to select the third signal if the first level is higher than the second level by more than a threshold amount and the fourth signal if the first level is not higher than the second level by more than the threshold amount.

6. The receiver according to claim 3, further comprising:
a comparator that compares the first and second levels and outputs a comparison result signal based on the comparison result,
wherein the control circuit controls the switching circuit based on the comparison result signal.

7. The receiver according to claim 1, further comprising:
a signal level detecting circuit for detecting a signal level of the first signal,
wherein the control circuit controls the switching circuit based on the detected signal level of the first signal.

8. The receiver according to claim 7, wherein the control circuit is configured to control the switching circuit to select the third signal if the detected signal level of the first signal is higher than a threshold amount and the fourth signal if the detected signal level of the first signal is not higher than the threshold amount.

9. The receiver according to claim 1, further comprising:
an antenna for receiving an RF signal;
a low-noise amplifier for amplifying the RF signal received from the antenna;
a local oscillator for outputting a local oscillating signal; and
a mixer for outputting the input signal by mixing the RF signal amplified by the low-noise amplifier and the local oscillating signal.

10. A method of generating a demodulated signal, comprising the steps of:
channel filtering an input signal to produce a first signal;
amplifying the first signal to produce a second signal;
performing one of two detection methods, including a first detection method that produces a third signal and a second detection method that produces a fourth signal; and
selecting one of the third signal and the fourth signal and outputting the selected signal through an output terminal as a demodulated signal.

11. The method according to claim 10, wherein the first detection method delays and detects the second signal to produce the third signal.

12. The method according to claim 10, wherein the second detection method performs pulse count detection or quadrature detection on the second signal to produce the fourth signal.

13. The method according to claim 10, wherein the first detection method delays and detects the second signal to produce the third signal and the second detection method performs pulse count detection or quadrature detection on the second signal to produce the fourth signal.

14. The method according to claim 10, further comprising the steps of:
detecting a signal level of the input signal as a first level; and
detecting a signal level of the first signal as a second level,
wherein the selecting between the third signal and the fourth signal is made based on a difference in the first and second levels.

15. The method according to claim 14, wherein the third signal is selected if the first level is higher than the second level and the fourth signal is selected if the first level is not higher than the second level.

16. The method according to claim 14, wherein the third signal is selected if the first level is higher than the second level by more than a threshold amount and the fourth signal is selected if the first level is not higher than the second level by more than the threshold amount.

17. The method according to claim 10, further comprising:
detecting a signal level of the first signal,
wherein the selecting between the third signal and the fourth signal is made based on the detected signal level of the first signal.

18. The method according to claim 17, wherein the third signal is selected if the detected signal level of the first signal is higher than a threshold amount and the fourth signal is selected if the detected signal level of the first signal is not higher than the threshold amount.

19. A receiver comprising:
an antenna for receiving an RF signal;
a low-noise amplifier for amplifying the RF signal received from the antenna;
a local oscillator for outputting a local oscillating signal;
a mixer for mixing the RF signal amplified by the low-noise amplifier and the local oscillating signal to produce a mixed signal;
a channel selection filter configured to receive the mixed signal from the mixer, filter the mixed signal, and output the filtered mixed signal as a first signal;
an amplifier configured to receive the first signal from the channel selection filter, amplify the first signal, and output the amplified first signal as a second signal;
a first detector configured to receive the second signal from the amplifier, delay and detect the second signal, and outputs the delayed and detected second signal as a third signal;
a second detector configured to receive the second signal from the amplifier, perform pulse count detection or quadrature detection on the second signal, and output the second signal that has undergone pulse count detection or quadrature detection as a fourth signal;
a switching circuit configured to select one of the third signal and the fourth signal and output the selected signal through an output terminal as a demodulated signal;
a comparator that compares voltage levels of the mixed signal and the first signal and outputs a comparison result signal based on the comparison result; and
a control circuit configured to control the switching circuit to select one of the third signal and the fourth signal based on the comparison result signal.

20. The receiver according to claim 19, further comprising:
a first signal level detecting circuit for detecting the voltage level of the mixed signal; and
a second signal level detecting circuit for detecting the voltage level of the first signal.
